(19) United States
(12) Patent Application Publication
(10) Pub. No.: US 2019/0272492 A1
(43) Pub. Date: Sep. 5, 2019

(54) Trusted Eco-system Management System

(71) Applicant: Edgile, Inc., Austin, TX (US)

(72) Inventors: Don Elledge, Austin, TX (US); William Mathies, Terre Haute, IN (US)

(73) Assignee: Edgile, Inc., Austin, TX (US)

(21) Appl. No.: 15/911,962

(22) Filed: Mar. 5, 2018

(51) Int. Cl. G06Q 10/06

(52) U.S. Cl. CPC G06Q 10/06393; G06Q 10/0635; G06Q 10/0637

(57) ABSTRACT

A method comprising: providing a database comprising: a plurality of organizations; a plurality of members; and a plurality of questions; generating an assessment for each of the plurality of members from a subset of the plurality of questions; serving each assessment generated to each of the plurality of members; receiving a completed assessment comprising answers; recording in the database each member's completed assessment; generating a report for at least one of the plurality of organization's eco-system wherein the eco-system comprises members from the plurality of members and the report comprises a trust score for the eco-system.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### Field of the Invention

This invention relates to the field of risk management and more specifically to a system for a user to understand inherent and residual risks in their vendor and partner eco-system.

### Background of the Invention

Organizations and individuals may be increasingly reliant on large, interconnected eco-systems to do business. An organization may rely on a plurality of members of their eco-system such as vendors, resources, supply channels, business partners, and distribution partners throughout all aspects of the organization. As the number of members in an organization's eco-system grows, managing the eco-system may become increasingly difficult. Each member of the eco-system may have inherent and residual risks associated with them, and the risks of each member may contribute to the overall risk posture of the organization. As the eco-system grows, so may the risk posture for certain aspects of the organization.

An organization's confidence or trust in certain aspects such as business trust, compliance trust, and cyber trust may be challenging to evaluate as the eco-system grows in size and complexity. Trust areas may be defined as the overall confidence of the organization that a certain aspect of the organization is in compliance, is adequately protected, and is within a manageable risk level. Trust areas may be evaluated by the methods and systems described herein. Trust areas may be difficult to evaluate as eco-system members become increasingly interconnected with the organization as certain aspects of members may become obfuscated to the organization. A member may serve more roles with less oversight and the organization may become unaware of all activities of the member. Furthermore, evaluating trust across the eco-system becomes increasingly complex as new members are added to the eco-system and increases the share of organization resources as the eco-system grows.

As previously stated, evaluating eco-system trust may become increasingly complex as the eco-system grows in number of members or as members themselves become increasingly complex. In some instances, evaluating the level of trust in members may be difficult as the information to evaluate trust may not be available to the organization. Members may be reluctant to share information with the organization if the member is not contractually or legally required to share certain information. Members themselves may not have evaluated the inherent and residual risks associated with their business and therefore, members may incorrectly respond to information or compliance requests by the organization. Additionally, members and the organization may not know the questions to ask, documents to review or information to collect for an accurate evaluation of trust.

With reference to compliance trust, organizations may not be aware of regulatory requirements of which they must comply. Organizations may also be unaware of changes in regulations affecting them. Furthermore, a member may be unaware of the regulatory compliance requirements associated to them and the organization they support, which may lead to the member unknowingly contributing to the noncompliance of the organization. With reference to business trust, an organization may be unaware of the potential business operational risks associated with a member because they may not know internal procedures and policies of the member. With reference to cyber trust, the organization may be unaware of cyber threats and vulnerabilities affecting their members. The organizations may be unaware of the complexity of and effectiveness of the member's information security program, information security policies and procedures, and information security controls in place.

Moreover, some members may belong to the eco-systems of two or more organizations. The first organization may order an assessment of a member who may also belong to the eco-system of a second organization. The second organization may also order an assessment of the same member. There is a loss of efficiency in evaluating the member twice as there may be overlap in the concerns and regulatory compliance requirements of the organizations requiring the member to answer questions twice over.

Consequently, there is a need in that art for improved methods for eco-system risk management that enables an organization to understand inherent and residual risks and overall risk posture of the organization and evaluate eco-system trust.

### BRIEF SUMMARY OF SOME OF THE PREFERRED EMBODIMENTS

These and other needs in the art are addressed in one embodiment by a method and system comprising a process for analyzing risk by utilizing a member specific assessment framework, which may be scored to generate an eco-system member specific risk score. The risk scores may be used to generate a risk report.

The foregoing has outlined rather broadly the features and technical advantages of the present embodiments in order that the detailed description that follows may be better understood. It should be appreciated by those skilled in the art that the conception and the specific embodiments disclosed may be readily utilized as a basis for modifying or designing other embodiments for carrying out the same purposes of the present invention.

### BRIEF DESCRIPTION OF THE DRAWINGS

For a detailed description of the preferred embodiments of the invention, reference will now be made to the accompanying drawings in which:

FIG. 1a illustrates an embodiment of risk assessment workflow process;

FIG. 1b illustrates an embodiment of a Venn-Diagram of an organization and vendors;

FIG. 1c illustrates an embodiment of a decision tree;

FIG. 2a illustrates an embodiment of an evaluation process for a vendor;

FIG. 2b illustrates an embodiment of an evaluation process for a vendor;

FIG. 3a illustrates an embodiment of a web application interface comprising components of eco-system trust;

FIG. 3b illustrates an embodiment of a web application interface comprising components of eco-system trust.

### DETAILED DESCRIPTION OF THE PREFERRED EMBODIMENTS

In embodiments, a method and system comprise a process for analyzing risk in an eco-system and developing reports on eco-system trust. Business risks to organizations may come from a variety of sources such as strategic risks, compliance risks, cyber risks, operational risks, reputational risks, and other risk sources. Risks may cause business harms that may result in a lawsuit or a loss in profit. A strategic risk may result from an implementation of a business strategy that may not go according to a pre-selected model or plan. The risk may take the form of a business plan that becomes less effective over time and may struggle to achieve the defined goals in the business plan. An example of a strategic risk may be reliance on a business plan that comprises selling a product at a lower cost than competitors. Should the competitors undercut the price, the long-term business strategy may be at risk. An evaluation may consider whether the member can continue to provide the organization with services at a competitive price point so the organization does not have to increase prices and can remain competitive. Business risks may also include risks to the continued business operations of organizations. A member of the eco-system may provide a vital service to the organization and if the member becomes insolvent or temporarily unable to provide the service, the organization may also be at risk for suffering an inability to continue business. A compliance risk may involve a risk to a member that is subject to government or private regulations. Penalties may occur for noncompliance of the business as well as members of the eco-system. Regulations may range from international agreements such as treaties, to federal regulations, to state and local regulations. A cyber risk may include scenarios such as a breach of intellectual property, trade secrets, and other kinds of proprietary data that the organization may need to be competitive. Other cyber risks may include impediment of normal business due to the unavailability of digital resources due to malicious attacks. Operational risks may result from breakdowns of internal procedures, people, and systems that may negatively impact business operations. Reputational risks refer to any potential or actual risks to an organization's reputation. Although only a few types of risk have been briefly discussed, one with ordinary skill in the art will understand that there are many other risks not specifically enumerated to which the disclosed systems and methods may apply.

An evaluation organization may provide a method for evaluating trust in an eco-system through a trusted eco-system risk platform. The trusted eco-system risk platform may comprise the tools and resources necessary to perform the method. The method may comprise defining the eco-system for a particular organization. As previously mentioned, an organization's eco-system may comprise members such as vendors, resources, supply channels, business partners, and distribution partners. An organization's eco-system and associated members may be stored in a database in the trusted eco-system risk platform. The trusted eco-system risk platform may further comprise a web-based portal configured to allow access to employees of the evaluation organization as well as the customer organizations who use the trusted eco-system risk platform.

An employee of the evaluation risk organization may identify risk areas for the customer organization and input the risk areas into the database. Risk areas may comprise various trust areas. A trust area may be defined as a container of logically relevant risk types. A trust area may be for example, without limitation, Business Trust, Compliance Trust and Cyber Trust. These trust areas can break down further into specific risk areas. For example, Business Trust can break down into Business Continuity, Physical Security, Policy and other business oriented risk areas. Compliance Trust can include FFIEC, PCI, HIPAA and other regulations and standards. Cyber Trust can include various cyber frameworks.

Trust areas identified for evaluation may be unique to the customer organization's business. For example, a bank may be identified as having a high regulatory compliance risk with regards to Federal Deposit Insurance Corporation (FDIC) regulations, Federal Reserve Board Regulations, Office of the Comptroller of the Currency (OCC) regulations, as well as operational risks related to the payment card industry (PCI), and cyber security risks arising from an online presence. The customer organizations may also identify additional risk areas. One specific example of a concern for a bank may be ATM transactions. The interbank networks facilitating ATM transactions may be an integral part of the bank's ATM operations. A disturbance to the interbank network by the members who provide the bank access to the interbank network may result in the inability of the bank to perform certain kinds of transactions. The bank may be particularly concerned about the business risks associated with the interbank network whether the bank may continue to operate normally if one of the members, such as a specific interbank network or members who provide access to the interbank network, were to cease operations. The interbank networks may present a business continuity risk to the bank.

To better understand the organization's risk posture and to evaluate the trust areas of the organization, an assessment of members of the eco-system may be performed. An assessment may comprise completing a survey or questionnaire by the member. The questionnaire may comprise questions that relate to a trust area to which the member is identified. Questions may derive from, without limitation, regulations, standards, information security frameworks, industry standard information risk questionnaires and customer supplied questions. The questions may be stored in a database that is referenced to generate the questionnaire based on the selected trust area to which the member is identified. A member may be identified to be associated with a plurality of trust areas and the questionnaire may comprise questions from each trust area to which the member is identified.

For example, a bank's eco-system may have a member who provides connectivity to credit cards and related services. That member may be selected to be evaluated on PCI standards as laid out in PCI-DSS (payment card industry data security standard). PCI-DSS may comprise standards relating to payment card transactions and storage of data. A specific requirement of PCI-DSS may be a requirement to install and maintain a firewall configuration to protect cardholder data and to not use vendor-supplies defaults for system passwords and other security parameters. The questionnaire may include these and other questions to evaluate if the member is compliant with PCI-DSS. In particular, questions derived from PCI-DSS may mainly be related to the compliance trust area as PCI-DSS may mainly comprise data security requirements. The member's answers to questions related to compliance trust may contribute to the member's compliance trust score and thereby the eco-system's compliance trust score as will be illustrated in further detail below.

The member who provides credit card services may also be selected to be evaluated based on compliance with NIST CSF (Cybersecurity Framework). NIST CSF may also require the maintenance of a firewall and may also require default passwords not be used. Since there is overlap between the requirements of the trust areas the member is questioned on, the member may only be asked the overlapping questions once. By eliminating overlap of questions, the member may be more effectively evaluated by saving resources required to answer the questionnaire.

The member who provides credit card services may also be a member in a plurality of organization's eco-systems. The member may be provided with a single questionnaire which comprises all questions related to every eco-system the member belongs to and each trust area for which the organizations choose to evaluate the member.

Assessments may also comprise on-site visits to a member's facilities to conduct an on-site assessment of the member. As with questions generated by regulations, standards, information security frameworks, industry standard information risk questionnaires and customer supplied questions, questions from on-site assessments and their answers may be stored in a database. Other sources of assessment data may comprise data gathered from public or subscription based databases. Some examples of data which may be gathered may include criminal records, court records, financial records, news feeds, stock price information, assessments of malware attacks, terrorist threats, etc.

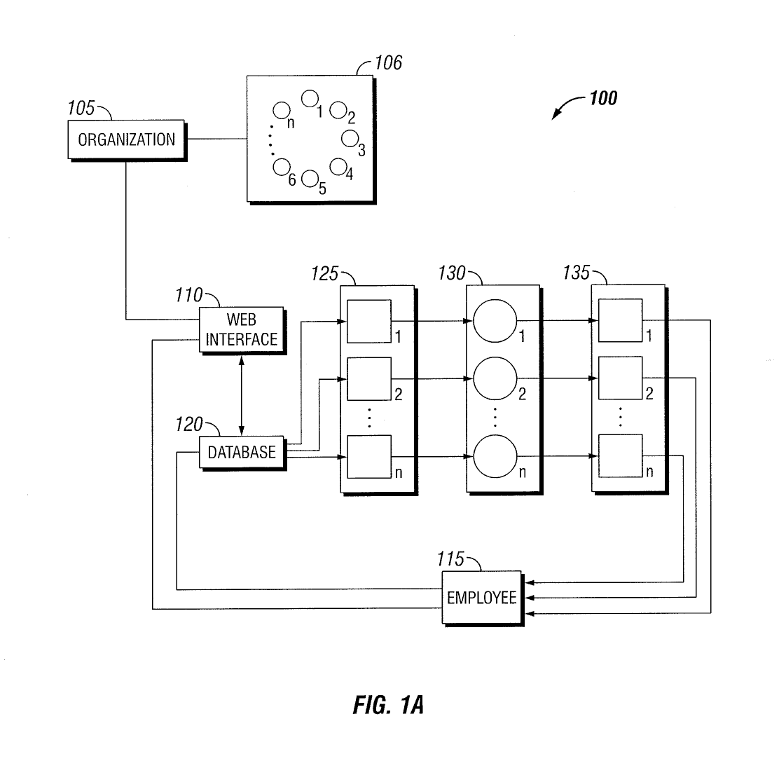

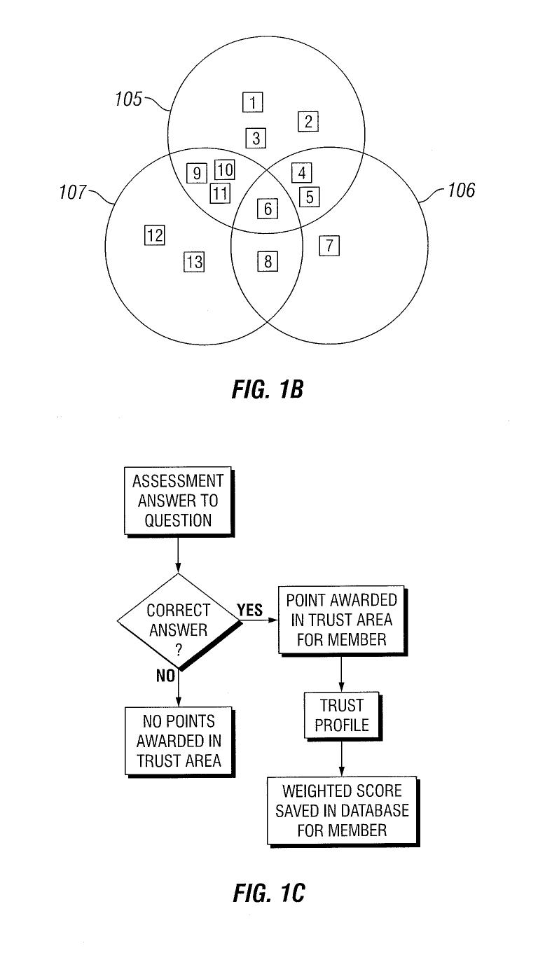

Example methods and systems comprising the risk management system as previously described will be illustrated in greater detail with reference to FIG. 1a. A risk assessment workflow process 100 is illustrated in FIG. 1a. An organization 105 may have an eco-system 106 comprising members 1 through n. Organization 105 may populate its eco-system into a web interface 110, which may interface with database 120. A risk evaluation organization employee 115 may also have access to web interface 110. As previously disclosed, areas for risk assessment may be selected based on risk areas in which organization 105 is interested. Employee 115 may also select risk areas for organization 105. The risk areas selected by organization 105 and employee 115 may be entered into the web interface 110 and stored in database 120. Risk areas selected may be based on the interests of organization 105 and the regulations, standards, and practices of which organization 105 may choose to comply. Risk areas selected may not include all risk areas organization 105 may be exposed to and may not prove actual compliance with all regulations to which organization 105 may be required to be compliant.

Questions 125 may be generated based on the selected risk areas entered in database 120 and the member's provided services to organization 105. Questions 125 may comprise question lists 1 though n, each containing the questions pertaining to the specific member 1 though n. Questionnaires 130 may be provided to a member wherein each questionnaire 1 through n may comprise the question lists 1 through n associated with each member. Questionnaires may be provided to each member 1 though n who may then complete the questionnaires to generate assessments 135. Assessments 135 may comprise evaluations 1 though n comprising answers to questions in the associated questionnaire for a member. The assessments may be reviewed by employee 115 before entry into database 120.

As previously disclosed, a member of a specific organization's eco-system may also be a member of a plurality of eco-systems of other organizations. FIG. 1b illustrates a Venn-Diagram of organization 105, organization 106, and organization 107 and members 1 through 13 who belong to the organizations' eco systems. FIG. 1b illustrates how members can be part of two or more eco-systems. For example, member 6 is included in the eco-system of all three organizations while members 4 and 5 are in organization 105's and organization 106's eco-system. Generating a questionnaire for member 6 may comprise gathering the trust areas organization 105, organization 106, and organization 107, associate with member 6, listing the questions associated with each trust area, evaluating if the question lists have overlapping questions, and generating a questionnaire with all the questions without overlap of questions. Similarly, generating a questionnaire for member 4 may comprise listing the trust areas organization 105 and organization 106 associate with member 4, listing the questions associated with each trust area, evaluating if the question lists have overlapping questions, and generating a questionnaire with all the questions without overlap of questions.

FIG. 1c illustrates a decision tree that may be applied to answers in the assessment. A member's score in a certain trust area may be based on the answers to the questions in the questionnaires completed by each member. The database previously mentioned may comprise the correct or expected answer to each question asked. For example, if a regulation requires that all users have a minimum password length of eight characters for logins, then the correct or expected answer would be that the member answered that they have a minimum password length enforcement of eight characters for logins. If the answer to a question is not the expected or correct answer for a certain question, no points may be awarded to the member's trust area that is associated with the questions. In the case of a password length question, the question may be in the cyber trust area and an incorrect answer would not increase the score of the member's cyber trust. A correct answer may initially award a point in the member's trust area for the trust area associated with the question. A trust profile may allow a weight to be assigned to each trust area. The trust profile may amplify the answer's importance, diminish its importance, or leave the importance the same of questions in trust areas. The trust profile may, for example, decrease the answer's importance of questions in the trust area by decreasing the weight of the trust area. In the case of a password length question, the organization may not value the NIST CSF cyber trust highly so correct answers to questions in the NIST CSF cyber trust may be given one-third the value instead of its full value, for example. Reducing the weight given to a correct answer in a trust area reduces the total score a member has in the trust area, thereby increasing the threshold to achieve a higher trust level in the trust area. In another example, the value given to correct answers of a trust area may be increased by a factor of three, thereby increasing the overall trust in the trust area. The multiplier applied by the trust profile has been disclosed as one third and three, but one of ordinary skill in the art would understand that any value of multiplier may be applied. In another example, the multiplier may be additive, subtractive, multiplicative, divisional, exponential, logarithmic, polynomial, or any combination thereof. The amount the trust profile may modulate the score assigned by questions of specific trust area may be determined by any factors, including, but not limited to, the organization's opinion or the organization's regulations, standards, information security best practices and industry standard information risk maturity models. The trust profile may generate a weighted score for each question in affected trust areas, which may then be stored in a database and associated with the member in the organization's eco-system.

A member may have a trust score in each trust area based on the weighted score from the trust profile. Trust levels for each trust area may be calculated from the sum, average, or applying an alternative mathematical formula of the weighted score from each question the member was selected to be assessed on based on the previously described trust areas of interest to the organization. As will be disclosed in further detail below, the member may be assessed on, for example and without limitation, 100 questions, of which only 75 may apply to a selected trust area selected by an organization for assessment. Questions assessed by vendors can be limited by the trust areas, cyber framework, industry-standard question set, regulations and standards, and specific questions selected by the customer. Additionally, customer supplied questions can be incorporated and made available to the members for assessment. The trust levels may be described for example, without limitation, as low, medium-low, medium, medium-high, and high, or any other qualitative risk measurement metric scale. The separation between each trust level or where each trust level ends and then the next trust begins may be based on a threshold which defines the bounds of the trust level. The trust thresholds are set by default for the organization's eco-system, however, the organization has the ability to manually adjust the trust thresholds. Adjustments to trust thresholds may impact one or all members in the organization's eco-system. As disclosed earlier, the trust levels are adjusted by the threshold. For example, without limitation, a low trust level may correspond to a score of less than 10, a medium trust level may correspond to a score of 50, and a score of high trust level may correspond to a score of greater than 100. The threshold for a member to cross from a medium-low trust to a medium trust in this example may be a score of 50. Additionally, a trust level may be calculated for member groups the member belongs to as well as overall eco-system. These concepts will be further disclosed below. The trust level for a member group may be calculated by multiple methods for a selected trust area. In Table 1, the member group may comprise members 1 through 3. A method of calculating the trust level may comprise calculating an average score of members 1 through 3 for a selected trust area. For example, an average for trust area 1 may be 6. If a threshold of 5 to 7 is set for medium trust, the average of trust area 1 may be described as medium. Additionally, the trust level for a member group may be the smallest or minimum value for all members in a trust area. In Table 1 for trust area 1, the minimum would be 3. If a threshold of 1 to 3 is low, the minimum value of 3 would make trust area 1 low. Similarly, the trust level of trust area 2 may be medium-low if a threshold is set at 4 for medium-low for an average, and low in the instance where minimum is selected as the calculation method. One of ordinary skill in the art would understand that the non-limiting examples presented herein only represent one instance of calculating a trust level for a member group. Any thresholds may be set as appropriate for a certain trust area and size of member group, and any number of members may be present in a member group.

TABLE 1

| | Member 1 | Member 2 | Member 3 | Average | Minimum |
|---|---|---|---|---|---|
| Trust Area 1 | 6 | 3 | 9 | 6 | 3 |
| Trust Area 2 | 3 | 2 | 7 | 4 | 2 |
| Trust Area 3 | 8 | 3 | 4 | 5 | 3 |

An alternate method of calculating a trust level for a member group may be a weighted average as illustrated in Table 2 and Table 3. Table 2 illustrates an example of a weighting scheme for a score. A score of 1-3 may be considered low, and the factor may be 1 to weight the score to low. Additionally, a score of 7-10 may be considered high, and thereby the factor weighting may be 5. These scores are merely illustrative examples, and one of ordinary skill should be able to select any weighting factors for a particular application. Table 3 illustrates the application of the weighted scores and weighted average for each member and trust area. Table 3 illustrates how the relatively low scoring of member 2 for each trust area may decrease the overall trust in the member group.

TABLE 2

| Score | Factor |
|---|---|
| 1-3 | 1 |
| 4-6 | 3 |
| 7-10 | 5 |

TABLE 3

| | | | | Weighted |
|---|---|---|---|---|
| | Member 1 | Member 2 | Member 3 | Average |
| Trust Area 1 | 6 | 3 | 9 | |
| Weighted Score | 3 | 1 | 5 | 3.0 |
| Trust Area 1 | | | | |
| Trust Area 2 | 3 | 2 | 7 | |
| Weighted Score | 1 | 1 | 5 | 2.3 |
| Trust Area 2 | | | | |
| Trust Area 3 | 8 | 3 | 4 | |
| Weighted Score | 5 | 1 | 3 | 3 |
| Trust Area 3 | | | | |

An alternate method of calculating a trust level for a member group may be an aggregation method illustrated in Table 4. Although only illustrated in 2-dimensions and thereby for 2 members, one of ordinary skill in the art would understand that the scheme illustrated below can mathematically be extended in infinite dimensions for an infinite member count. A score for a member's trust area may be bounded as discussed above with thresholds set for a particular score in a trust area. A first member may be represented on by the rows of Table 4 and a second member may be represented by the columns of Table 4. An intersection of the score of the first and second member may represent the aggregated trust in a particular trust area for the first and second member. One of ordinary skill in the art will appreciate that the concept of aggregate scoring can be logically extended in computer code for any arbitrary number of members. For example, in structured query language (SQL), an aggregate score may be created by a JOIN clause that may combine rows and columns from various tables to calculate an aggregate score.

TABLE 4

| | | | | | |
|---|---|---|---|---|---|
| | Low | Low | Moderate | Elevated | High |
| | | Moderate | | | |
| Low | Low | Low | Low | Low | Low |
| | | | | Moderate | Moderate |
| Low | Low | Low | Low | Low | Moderate |
| Moderate | | Moderate | Moderate | Moderate | |
| Moderate | Low | Low | Moderate | Moderate | Moderate |
| | | Moderate | | | |
| Elevated | Low | Low | Moderate | Elevated | Elevated |
| | Moderate | Moderate | | | |
| High | Low | Moderate | Moderate | Elevated | High |
| | Moderate | | | | |

Eco-system trust areas may also be calculated by any of the previously disclosed methods. Eco-system trust may comprise calculating trust scores for each eco-system trust area such as business, cyber, and compliance, for example, by the methods disclosed above for each member of the eco-system.

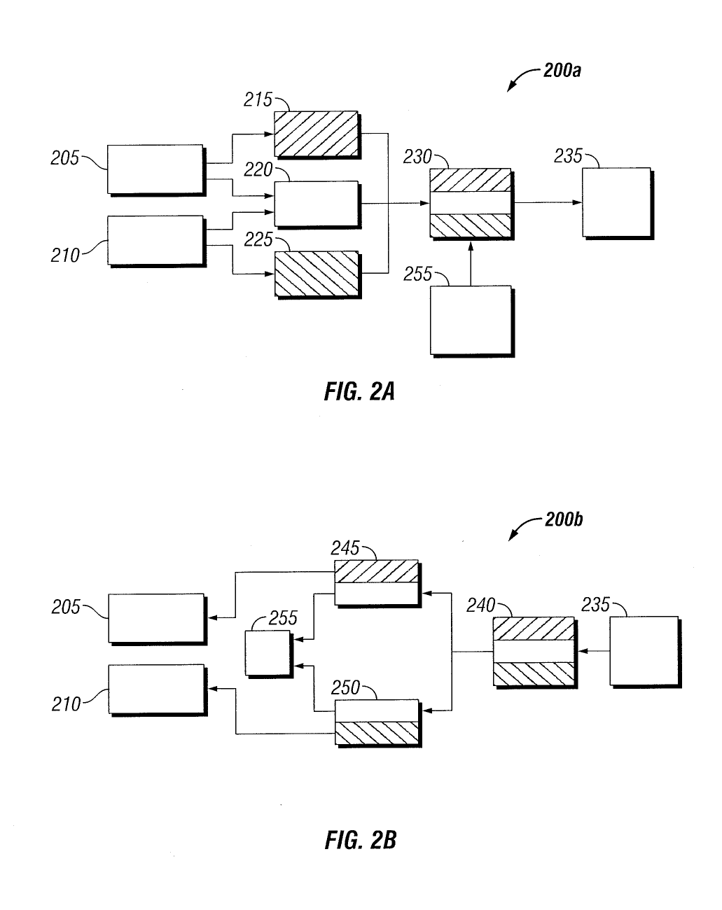

FIGS. 2a and 2b illustrate an evaluation process 200a and 200b respectively for a member. A first eco-system 205 from a first organization and a second eco-system 210 from a second organization may share a member 235. First eco-system 205 may be concerned with first trust area 215 while second eco-system 210 may be concerned with second trust area 225. First eco-system 205 may not be concerned with second trust area 225 as it may not apply to the business operations of the first organization, or member 235 may not provide services relevant to second trust area 225 to the first organization. Similarly, second eco-system 210 may not be concerned with first trust area 215. Both first eco-system 205 and second eco-system 210 may be concerned with mutual trust area 220. A questionnaire 230 comprising questions related to first trust area 215, second trust area 225, and mutual trust area 220 may be prepared based on questions related to each trust area gathered from database 255. The questionnaire may be prepared by an assessment engine. The assessment engine may be computer software that interfaces with database 255 to generate questionnaire 230 from trust area 215, trust area 225, and mutual trust area 220. As previously disclosed, database 255 may comprise questions related to each trust area and risk areas identified by employees of the risk evaluation organization. The questionnaire 230 may be presented to member 235 for completion. In the process 200a of FIG. 2a, first eco-system 205 and second eco-system 210 are unaware of the other eco-system's trust areas that may be included in questionnaire 230. The process 200a of FIG. 2a allows for anonymity between different organizations by making the questionnaire agnostic to the member 235. The member 235 does not know which organizations are asking the questions because the organization is only presented with one assessment questionnaire. In the example given above, 215, 220 and 225 represent trust areas that the eco-systems 205 and 210 select. 215, 220 and 225 may also represent standard question sets or specific questions that the eco-systems 205 and 210 may be interested in including in their assessment of the member 235.

FIGS. 2a and 2b illustrate a process 200b of member 235 responding to questionnaire 230. Member 235 may answer questionnaire 230 to generate assessment 240. Assessment 240 may comprise answers to questions from questionnaire 230 corresponding to questions from database 255. Assessment 240 may comprise answers to questions retrieved from database 255 based on first trust area 215, second trust area 225, and mutual trust area 220. The portion of answers in assessment 240 corresponding to first trust area 215 and mutual trust area 220 may be separated into first individual assessment 245. Similarly, the portion of answers in assessment 240 corresponding to second trust area 225 and mutual trust area 220 may be separated into second individual assessment 250. First individual assessment 245 and second individual assessment 250 may be stored in database 255 and sent to first eco-system 205 and second eco-system 210.

Although FIGS. 2a and 2b are directed to two eco-systems and three trust areas, one of ordinary skill in the art would understand that the method described herein may apply to a plurality of eco-systems and a plurality of trust areas. Member 235 may belong to a plurality of eco-systems. A questionnaire may be provided to member 235 corresponding to questions generated by each eco-system to which member 235 belongs. An eco-system may have a plurality of overlapping mutual trust areas and individual trust areas. Through the methods described in FIGS. 2a and 2b, a member may be evaluated once to cover each permutation of the eco-system and questions associated with the eco-systems. The methods described herein may be more efficient due to the questionnaire containing all questions associated with the eco-systems the member is a part of without overlapping and multiple redundant questionnaires from each individual organization and associated eco-system. Additionally, each eco-system is able to assess the member with anonymity due to the plurality of questions associated with individual and mutual trust areas presented to the member.

As disclosed, the trusted eco-system risk platform may comprise a web interface. A web interface may be, for example, a website page, a mobile application, a desktop application, or any combinations thereof. The web interface may allow a user to visualize the trust associated with members, eco-system member groups, eco-system trust areas, and overall eco-system trust. The web interface and graphic visualizations will now be described in further detail.

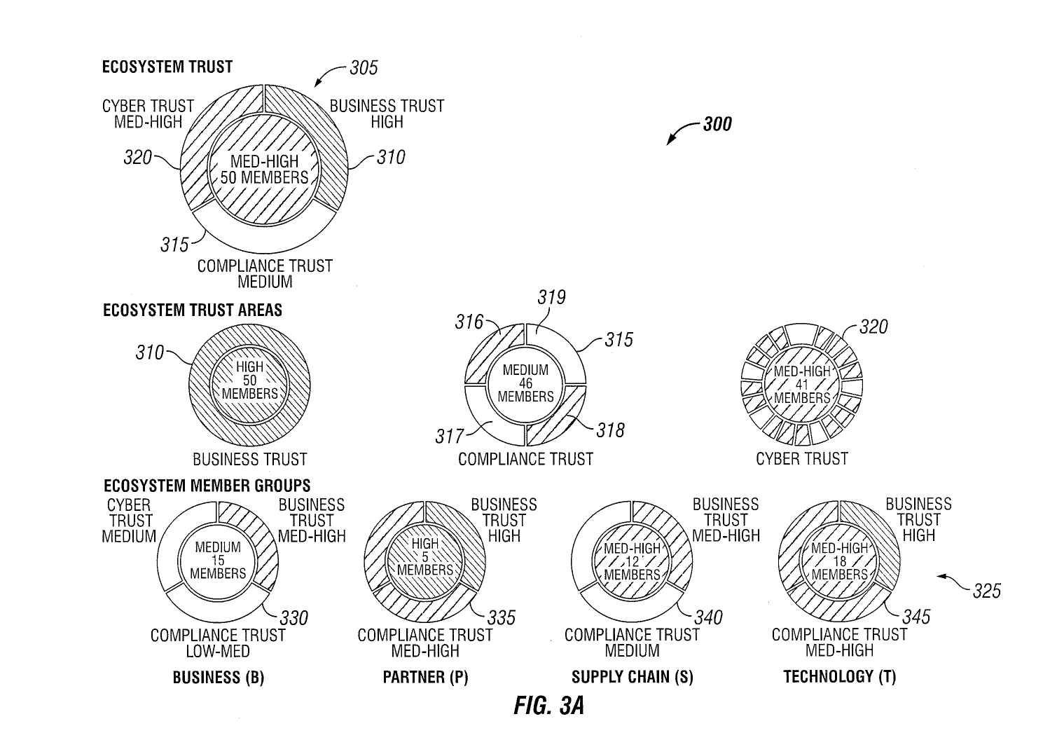

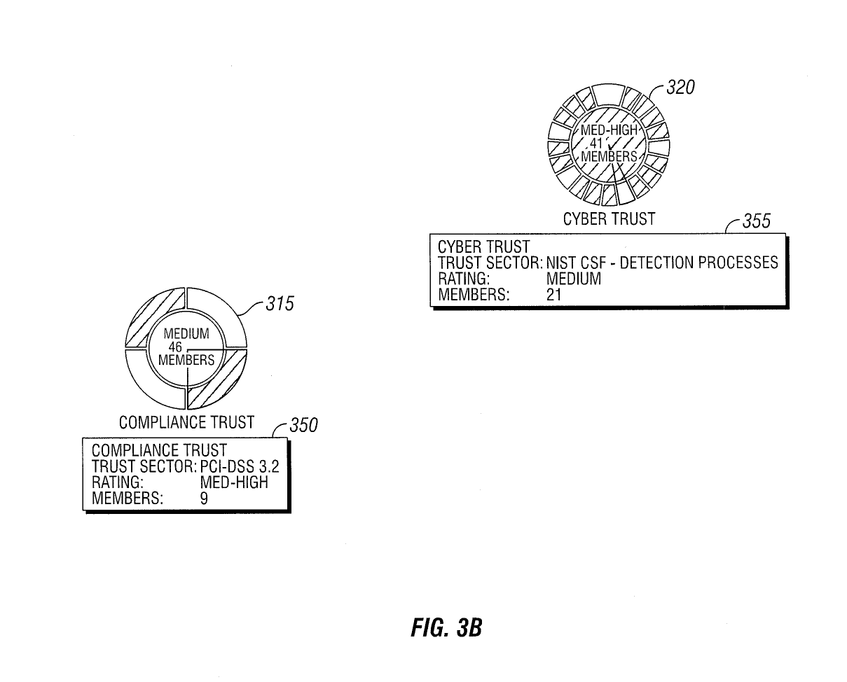

A graphic visualization comprising hierarchy of trust 300 is illustrated in FIG. 3a. The graphic visualization may be part of a web interface. Although referred herein as a web interface, one of ordinary skill in the art will understand that the web interface may comprise a web page, a computer application, a mobile application, a touch interface application, or any other method which may display the graphic visualizations. A dashboard may comprise a visual representation of the eco-system trust 305 and the components thereof. Eco-system trust 305 may comprise all or selected members of the eco-system and their contributions to the overall eco-system trust 305. Eco-system trust 305 may comprise multiple eco-system trust areas including business trust 310, compliance trust 315, and cyber trust 320. Each eco-system trust area may comprise members of the eco-system and their weighted score contributions to the trust area. As illustrated in FIG. 3a, the eco-system trust areas may comprise lower level trust areas. For example, compliance trust 315 may comprise first lower level trust area 316, second lower level trust area 317, third lower level trust area 318, and fourth lower level trust area 319. As previously disclosed, lower lever trust areas may comprise, for example, PCI, HIPAA, etc. As also disclosed earlier, a trust area may be defined as a container of logically relevant risk types.

Eco-system member groups 325 may contribute to the trust score of each eco-system trust area. As previously disclosed, the trust score may be calculated by multiple methods and may be an aggregate of the weighted trust scores from each member for each trust area. Eco-system member groups may include the members classified by their position within the eco-system and the services they provide to the organization whose eco-system to which the members belong. Some classifications of members may include business 330, partner 335, supply chain 340, and technology 345. As illustrated in FIG. 3a, each eco-system member group may comprise a cyber trust score, a business trust score, and a compliance trust score. Hierarchy of trust 300 may be displayed in a web-based application wherein a user may derive further details about eco-system trust 305.

FIG. 3b illustrates a web application interface comprising components of eco-system trust 305. As previously disclosed, eco-system trust 305 may comprise multiple eco-system trust areas. Cyber trust 320 and compliance trust 315 are illustrated in FIG. 3b. For instance, a user may mouse over or by any other suitable means select a portion of the eco-system trust area to access more details such as the title of the trust area, the individual trust area rating, and the number of lined eco-system members to the trust area, for example. As illustrated in FIG. 3b, a popup 350 for compliance trust 315 may comprise a trust area titled PCI-DSS 3.2 which stands for payment card industry (PCI) data security standard (DS S) version 3.2. The trust rating is medium-high with 9 total members who have been selected to be included in the trust area. A popup 355 for cyber trust 320 may comprise a trust area titled NIST CSF—Detection Processes, which stands for National Institute of Standards and Technology cybersecurity framework. The trust rating is medium with 21 members. Although only certain trust areas have been mentioned, each trust area associated with a eco-system trust area may be displayed as a user mouses over or accesses by any other suitable means each trust area.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

1. A method comprising:
providing a database through a central processing unit, a visual display, and an input device, wherein the database comprises:
a plurality of organizations, wherein at least one of the plurality of organizations is a part of at least one eco-system;
a plurality of members, wherein the at least one eco-system comprises the plurality of members; and
a plurality of questions;
generating an assessment for each of the plurality of members from a subset of the plurality of questions with the central processing unit, wherein the subset of the plurality of questions is void of overlapping questions;
serving each assessment generated to each of the plurality of members through the central processing unit;
receiving a completed assessment comprising answers through the central processing unit;
recording in the database each member's completed assessment;
generating a report for the at least one eco-system of at least one of the plurality of organizations through the central processing unit, wherein the report comprises a trust level for the at least one eco-system.

2. The method of claim 1 wherein the database further comprises a list of trust areas each of the plurality of organizations associates with each of the plurality of members.

3. The method of claim 2 wherein the database further comprises a list of each question from the plurality of questions associated with each trust area.

4. The method of claim 3 wherein the step of generating the assessment comprises:
listing the trust areas associated with each of the plurality of members;
listing the questions associated with each of the trust areas to generate a question list, wherein the question list is the subset of the plurality of questions;
evaluating the question list for overlapping questions; and
generating the assessment from the question list without overlapping questions.

5. The method of claim 3 wherein the step of recording the assessment comprises storing in the database the answers and associating the answers with each corresponding question.

6. The method of claim 5 wherein the step of generating the report comprises:
generating a list of trust areas, associated questions, and corresponding answers for each member of an organization's eco-system;
assigning a score to each corresponding answer based on if the corresponding answer is an expected answer;
summing or applying an alternative mathematical function to the score of each corresponding answer to generate a trust score for each of the trust areas; and
displaying the report comprising the trust score for each of the trust areas to a user.

7. The method of claim 6 further comprising:
applying a weighted trust profile to each corresponding answer, each trust area, or both.

8. The method of claim 7 wherein the weighted trust profile comprises a multiplier, wherein the multiplier is additive, subtractive, multiplicative, divisional, exponential, logarithmic, polynomial, or combinations thereof.

9. The method of claim 8 further comprising a step of at least one of the plurality of organizations defining trust areas associated with each member of the organization's eco-system by entering into the web interface the trust areas associated with each member.

10. The method of claim 9 further comprising a risk management associate defining trust areas associated with each member of the organization's eco-system by entering into the web interface the trust areas associated with each member.

11. The method of claim 6 further comprising:
summing or applying an alternative mathematical function to the trust score for each lower level trust area associated with a higher level trust area to generate the trust level.

12. The method of claim 6 wherein the report is displayed on a dashboard through the web interface.

13. The method of claim 1 further comprising a step of at least one of the plurality of organizations defining its eco-system by entering into a web interface the organization's member list, wherein the web interface is coupled to the database.

14. A system comprising:
a central processing unit;
a visual display;
an input device;
a database comprising:
a plurality of organizations, wherein at least one of the plurality of organizations is a part of at least one eco-system;
a plurality of members, wherein the at least one eco-system comprises the plurality of members;
a plurality of questions, wherein a subset of the plurality of questions is individually associated with each of the plurality of members and void of overlapping questions; and
answers to each of the plurality of questions is individually associated with each of the plurality of members;
an assessment generation engine configured to generate an assessment for each of the plurality of members from a subset of the plurality of questions;
a report generation engine configured to generate a report for the at least one eco-system of at least one of the plurality of organizations, wherein the report comprises a trust level for the at least one eco-system.

15. The system of claim 14 wherein the assessment engine configured to generate the assessment for the plurality of members from a subset of the plurality of questions by performing the steps comprising:
listing the trust areas associated with each of the plurality of members;
listing the questions associated with each of the trust areas to generate a question list, wherein the question list is the subset of the plurality of questions;
evaluating the question list for overlapping questions; and
generating the assessment from the question list without overlapping questions.

16. The system of claim 14 wherein the report generation engine configured to generate a report of the plurality of organization's eco-system by performing the steps comprising:
generating a list of trust areas, associated questions, and corresponding answers for each member of an organization's eco-system;
assigning a score to each corresponding answer based on if the corresponding answer is an expected answer;
summing or applying an alternative mathematical function to the score of each corresponding answer to generate a trust score for each of the trust areas; and
displaying the report comprising the trust score for each of the trust areas to a user.

17. The system of claim 14 further comprising a trust profile.

18. The system of claim 14 further comprising a web interface coupled to the database.

19. The system of claim 18 wherein the web interface is configured to display the report to a user.

20. The system of claim 17 wherein the web interface is configured to allow at least one of the plurality of organizations defining its eco-system by entering into a web interface the organization's member list and wherein the web interface is further configured to allow a risk management associate to define trust areas associated with each member of the organization's eco-system by entering into the web interface the trust areas associated with each member.
